(19) United States
(12) Patent Application Publication
(10) Pub. No.: US 2013/0050506 A1
(43) Pub. Date: Feb. 28, 2013

(54) PIXEL LEVEL CARBON NANOTUBE SENSOR ARRAY AND REAL TIME IMAGE PROCESSING SYSTEM

(71) Applicants: Mark Allen Lanoue, Long Beach, MS (US); Janek Kaliczak, Aptos, CA (US)

(72) Inventors: Mark Allen Lanoue, Long Beach, MS (US); Janek Kaliczak, Aptos, CA (US)

(73) Assignee: Mark Allen Lanoue, Long Beach, MS (US)

(21) Appl. No.: 13/218,563

(22) Filed: Aug. 26, 2011

(51) Int. Cl. H04N 5/225; B82Y 15/00

(52) U.S. Cl. 348/207.1; 977/954; 977/742; 348/E05.024

(57) ABSTRACT

The carbon nanotube (CNT) imaging system combines many sensor nanotubes into a containment vessel that is utilized as a pixel in a multipixel array that is assembled in a similar row and column configuration as other type of 2D sensors. The individual CNT sensor elements inside this pixel containment vessel may have many different carbon nanotubes with many different spectral frequencies. This will permit much faster acquisition of specific spectral data and the assemblage of spectral data cubes much faster than camera utilizing conventional optomechanical spectrographs or similar acoustic LCD filter gates for the same. The system could also contain emitter carbon nanotubes to emit coherent light back out through the optical lens system to act to provide range information or function as a spectral illuminator for the system.

### CROSS REFERENCE TO RELATED APPLICATIONS

This patent is a continuation-in-part of application Ser. No. 61/331,428 filed May 5, 2010, entitled “Real Time Wavelength Selectable Imaging Array and Image Processing System” This patent application has been incorporated for reference.

### FEDERALLY SPONSORED RESEARCH

Not Applicable

### SEQUENCE LISTING OR PROGRAM

Not Applicable

### BACKGROUND OF THE INVENTION

1. Field of the Invention

This application relates to the field of carbon nanotube pixel-level sensors, emitters, associated electronics and image processing.

2. Prior Art

The field of sensor array based systems have been discussed in detail elsewhere. Sensor arrays have been fabricated out of many materials, including CMOS, sCMOS, carbon nanotubes and others. These systems use each pixel element in the array to capture data, light or other function. Some of these units use multiple layers, or other configurations to capture the light onto each sensor unit in the array. Carbon nanotubes have been used to make many devices, including sensors, FETs, electrochemical, electromechanical as well as conductor applications. These devices take advantage of the fact that the two types of nanotube configurations, SWCNTs (single walled carbon nanotubes), and MWCNTs (multiwalled carbon nanotubes) each have different properties.

Carbon nanotubes are made of a carbon-based tube-shaped material that can be described as graphitic sheets, also called graphene sheets, rolled into a tube that has a diameter measuring on the nanometer scale. A nanometer is one-billionth of a meter, or about one ten-thousandth of the thickness of a human hair. Carbon nanotubes are unique “one dimensional systems” which can be envisioned as rolled single sheets of graphite (or more precisely graphene). This rolling can be done at different angles and curvatures resulting in different nanotube properties. Those tubes, or cylinders, can be closed at both extremities due to the introduction of pentagons into the hexagonal graphitic lattice. The graphite layer appears somewhat like a rolled-up chicken wire with a continuous unbroken hexagonal mesh and carbon molecules at the apexes of the hexagons

Two types of carbon nanotubes are known: Single-Walled Carbon Nanotubes (SWCNT) and Multi-Walled Carbon Nanotubes (MWCNT). Depending on how the grapheme sheet is wrapped into a tube, three different types of single-walled carbon nanotubes are built: zig-zag, armchair, and chiral. This structural feature is called chirality and describes the twist of a tube. In order to determine in which way a tube is twisted, or, in other words, its chirality, one has to count the number carbon atoms moving along the unit vectors a1 (n) and a2 (m) from a carbon atom to its equivalent one on the lattice. A single-wall carbon nanotube can be imagined as graphene sheet rolled at a certain “chiral” angle with respect to a plane perpendicular to the tube's long axis. Photoluminescence from SWCNT, as well as optical absorption and Raman scattering, is linearly polarized along the tube axis.

When the diameter of a nanotube is small, a precise measurement of diameter can reveal its chirality since there is one-to-one correspondence between these two quantities. Consequently, SWCNT can be defined by its diameter and chiral angle. The chiral angle can range from 0 to 30 degrees. However, more conveniently, a pair of indices (n, m) is used instead. The indices refer to equally long unit vectors at 60° angles to each other across a single 6-member carbon ring. In MWCNT their lengths are from hundreds of nanometers to tens of micrometers, with diameter of few to hundreds of nanometers.

The diameter typically varies in the range 0.4-40 nm (i.e. “only” ˜100 times), but the length can vary ˜10,000 times reaching 18.5 cm. Thus the nanotube aspect ratio, or the length-to-diameter ratio, can be as high as 132,000,000 which is unequalled by any other material. Consequently, all the properties of the carbon nanotubes relative to those of typical semiconductors are extremely anisotropic (directionally dependent) and tunable.

Carbon nanotubes have many structures, differing in length, thickness, and in the type of helicity and number of layers. Although they are formed from essentially the same graphite sheet, their electrical characteristics differ depending on these variations, acting either as metals or as semiconductors. As a group, Carbon Nanotubes typically have diameters ranging from <1 nm up to 50 nm. Their lengths are typically several microns, but recent advancements have made the nanotubes much longer, and measured in centimeters. Light-emitting diodes (LEDs) and photo-detectors based on a single nanotube have been produced. For specific information on carbon nanotubes reference “Carbon Nanotubes,” M. S. Dresselhaus, G. Dresselhaus, Ph. Avouris (Eds.), Topics in Applied Physics, 80, ISSN: 0303-4216 (printed version), ISSN 1437-0859 (electronic version).

In reference 1, it is stated that the injected electrons and holes are confined in the nanotube structure, and when they meet, they are neutralized. If their net momentum is zero and they have opposite spin, they can recombine and give off the recombination energy in the form of light, this mode of recombination takes place, and produces a single-molecule, electrically controlled light source. Unlike conventional light-emitting diodes, which involve fixed p-n junctions produced by doping, the SWCNT light source is a three-terminal device that involves no doping and also allows control of the emission intensity and the position of the emitting spot along the length of the CNT.

The diameter of the CNT defines the wavelength of the emitted light, typically in the infrared range. The reverse process of photocurrent generation with a significant yield by photoexcitation of a CNTFET device has also been demonstrated. This single CNT device can function as an electrical switch, a light emitter, or a light detector, depending on the biasing.

In reference 2, the work states that it has been shown that light emission can be observed from a single nanotube by appropriate choice of gate and drain voltage. In that case the number of photons is proportional to the number of electrons (the electron current) and the number of recombination attempts (given by the number of holes, i.e. the hole current). Thus the number of emitted photons is proportional to the product of hole and electron current. Both models lead to an exponential increase of the number of emitted photons with applied drain voltage (at the maximum value for V_{g}=V_{d}=2). This follows naturally from the variation of the OFF current because the voltage requirement for maximum light emission is identical to the OFF state.

The manufacture and setup of optical sensors and arrays is discussed elsewhere, such as in U.S. Pat. No. 7,780,918, to Brent M. Segal et al Aug. 24, 2010. In U.S. Pat. No. 7,129,467 to Wincheski et al. Oct. 31, 2006, a description of a carbon nanotube based light sensor is described. This sensor indicates that carbon nanotubes are deposited on a substrate and electrical circuitry provided to use the carbon nanotubes as conductors and has means for detecting the voltage of the nanotube array elements. In addition, it outlays the means for manufacturing the semiconductive base and which substances are used to modify said sensor.

Carbon nanotube devices have been thoroughly discussed and their photoabsorbtion quality known, as in U.S. Pat. No. 7,459,312, to Hongjie Dai and Robert J. Chen, Dec. 2, 2008, that describes a method of desorbing molecules from nanotubes using UV light, as well as applying a voltage across the nanotube to detect the change in the electrical properties of the nanotube.

In U.S. Pat. No. 7,286,210 to John W. Pettit, Oct. 23, 2007, a carbon nanotube passive sensor that operates by causing a wavelength dependent change in the optimal characteristics of CNT material. This patent is for a system that is not dependent on the amplitude of the signal and does not affect encoded material sent through an optical network to be received by this CNT sensor. This invention design describes the carrying of signaling information in a network and provides proper transference of the information regardless of amplitude changes in the signal.

In U.S. Pat. No. 6,632,701, to Richard B. Merrill, Oct. 14, 2003 describes how a multilayer quantum well works and the row and column feeds for the specific detector layer for the three individual well layers. The active pixel sensors in this case are three absorption layers near the semiconductor surface, employing red, green and blue sensitive layers out horizontally in a pattern. The pixel container system utilizes CNT sensors of similar detection value located in each pixel container but collecting the data in a similar manner. The individual spectral sensors located in each pixel container could represent more than just the red, green and blue primaries by having many CNT sensors located in each pixel container. So that a CNT sensor located in all the containers and sensitive to visible light could all be collected as a single layer whereas another CNT sensor sensitive to infrared light and also located in each pixel container could collect data for the infrared frequency represented. These layers and a plurality of many different layers could then be collected and represented in a common hyperspectral data cube for processing.

In U.S. Pat. No. 7,645,497 to Todd M. Spath, Jan. 12, 2010 provides alternatives to conventional substrates and provides a more stable medium for holding the carbon nanotube. Also the layering technology could also support additional functionality the carbon nanotubes when they are in place. The technology described herein is more in line with display systems and how the polymer materials utilized can make a longer lasting display. OLED technology utilizing SWCNT technology is geared towards utilizing mass production polymer technology which utilizes much higher temperatures in producing these substrates.

Sensor processing systems in general are known, and have been used for a diverse range of image sensing processes such as disclosed in, for example, in U.S. Pat. Application No. 2007/0041063 to Kitada and Takashi, Feb. 22, 2007 and the related U.S. Pat. No. 7,646,074 to Anderson, et al., Jan. 5, 2010. 7,661,075 to Anderson, et al., Feb. 9, 2010. Recently, carbon nanotubes have been used as sensor components such as in U.S. Pat. No. 7,642,582 to Cheon-Man Shim, Jan. 12, 2010.

U.S. Pat. Application No. 2009/0302411 to Dominic Massetti, Dec. 10, 2009 incorporates a carbon nanotube sensor, but has chosen to illuminate the sensor from the backside and contains filters to filter out unwanted wavelengths of radiation, such as infrared light. Using a sensor that can capture a wide range of electromagnetic radiation, from a single nanotube or N-number of nanotubes is desirable.

In Pat. Application No. U.S. 2007/0206242, Scott Smith, 2007, Sep. 6, explained that each pixel has a hyperspectral filter, which means a very narrow bandwidth at a specific frequency; which also means that it only gets data for a specific frequency at only that particular location. Even though an image could be produced this is limited to detecting a lot of individual spectral frequencies fast. So each has a lens and HSI filter on each pixel. The main advantage is speed. This system does not produce a DATCUBE, it is impossible to do so because you are not looking at an entire image for each spectral slice only one to a few pixels. It is classed as a multi array image sensor.

In U.S. Patent Application 2008/0225148 Christopher Parks, Sep. 18, 2008, eludes to the fact that there is an image sensor to replace existing ones. Their invention relates to the field of CMOS active pixel images and reducing the size if the pixel, they do not collect the image sensors into a pixel.

In Patent Application No. U.S. 2005/0248768 Nov. 10, 2005 using CNT, their system has the benefits of a passive optical sensor which operates by causing a wavelength-dependent change in the optical characteristics of a carbon nanotube. Both of these do not collect them into a container device to act as a pixel with many spectral frequencies.

In these and other carbon nanotube implementations, nanotubes devices that exhibit flexibility in sensitivity to and emission of electromagnetic radiation in pixel container integrated into an imaging system are desirable. For instance, changing the frequencies to which individual or groups of nanotubes sense electromagnetic radiation enables the collection of a spectrum of light at each pixel container and at each individual pixel element.

These pixel containers hold from 1-N carbon nanotube sensing and emitting units. By using both sensing and emitting elements, it is possible to have both an imaging and range finding capability in one container. By integrating these two capabilities, it is possible to create a 3D image that can be used in many different settings including at the cellular level. In previous implementations, these iterations have been separated and not applicable to imaging systems. In addition, practical applications have been limited, due to the fact that most implementations simply integrate testing protocols with the sensor design.

### SUMMARY OF THE INVENTION

The present invention is directed to overcoming the above mentioned challenges and others related to carbon nanotube devices and their implementations. The present invention is exelempfied in a number of implementations and applications, some of which are summarized below.

According to the example embodiment of the present invention, the system is receives and/or emits optical electromagnetic radiation using carbon nanotubes in a wide variety of spectral frequencies. The containers that hold at least one to a plurality of carbon nanotubes are the pixel elements, which together make up a complete sensor. The pixel container includes carbon nanotube sensor elements, which are chosen based on the wavelength of light that can be sensed or emitted. They are linked by a row and column scheme throughout the entire sensor, and are accessed when each spectral layer (frequency) is read.

In one embodiment, the nanotube sensor elements receive light and via connections with the integrated electronics, and produce a voltage. This signal is read by the electronics and passed to the other parts of the sensor package. This signal is interpreted by the system, and related to each pixel container in the system which ultimately reads the range of electromagnetic signals and produces a 2D or 3D data cube.

The pixel containers are arranged such that the imager can read one row or one column at a time, or using binning, a group of pixel containers in one location. The model for the imaging system is based on a hyperspectral imager, but could be replaced by another imager as technology progresses.

The sensor setup is composed of two lenses to focus the light, which can be moved as the imaging dictates, a focal plane shutter, either a traditional one, in one embodiment, an iris focal plane, or none at all, for the emitter setup, another focusing lens and the sensor which is composed of one or a plurality of pixel containers in a row and column configuration. The spectral camera system can then be constructed in such a manner that it can contain traditional focal and focus plane adjustments.

In each of these pixel containers one or n number of carbon nanotubes reside, and are grouped based on the electromagnetic frequency they can sense or emit. These nanotubes can be arranged, vertically or horizontally or other configuration. Each pixel container receives a particular spectrum of light and in turn generates voltage. The attached electronics can be layered or sitting next to the pixel containers. They process the voltage and perform AC/DC conversion, or other basic functions. Each nanotube is connected via nanoelectronics to further processing systems.

In another embodiment, the sensor elements emit or fluoresce based on the bias voltage applied to one or a plurality of emitters contained in the pixel container. The sensor elements, carbon nanotubes, when grouped or activated at the same time can produce a particular spectrum of light.

The signal travels along the electronics coupled with the system, which perform functions such as row to column, AC/DC conversion and other functions. This signal then travels to a waiting processing device, via nanowires, such as a computer, which could have 1 to many cores and attached GPGPU. The theorems needed to process the sensor data can be processed by the multiple cores and fed to a ROM that contains all of the theorems and other necessary processing routines. After processing, the resulting image is displayed on a viewing device and manipulated with software

The GPU C programming environment simplifies many-core programming and enhances performance by offloading computationally-intensive activities from the CPU to the GPU. It enables developers to utilize the Graphics Processing Units (GPU's) to solve the most complex computation-intensive challenges.

Other objects, advantages and novel features of the present invention will become apparent from the following detailed description of the invention when considered in conjunction with the accompanying drawings.

### BREIF DESCRIPTION OF THE DRAWINGS

Some of the features, advantages and benefits of the present invention having been stated, others will become apparent as the description proceeds when taken in conjunction with the accompanying drawings in which:

FIG. 1 conventional hyperspectral imaging system utilizing spectograph and sensor 100321 FIG. 2A carbon nanotube imaging container including carbon nanotube sensing elements

FIG. 2B shows the carbon nanotube sensing element containing carbon nanotube sensors and carbon nanotube emitter elements

FIG. 3A carbon nanotube imaging system with focal plane shutter and nanotube array structure

FIG. 3B Carbon nanotube imaging system with iris leaf shutter and nanotube array structure

FIG. 3C Carbon nanotube imaging system without a spectrograph and a nanotube array structure

FIG. 3D Carbon nanotube imaging system without a spectrograph with both sensors and emitters

FIG. 4 Carbon nanotube array with lightsource, sensor elements, electrical connections to electronics and the construction of a datacube

FIG. 5 carbon nanotube pixel imaging system control structure

### DETAILED DESCRIPTION

### Detailed Description of Embodiments

In the following detailed description of the embodiments reference is made to the accompanying drawings, that show by way of illustration, specific embodiments of the invention. Reference will now be made to the detailed embodiments of the invention. In the drawings, like numerals describe similar components throughout several views. Other embodiments may be utilized and structural and logical and electrical changes can be made without departing from the scope of this invention. Moreover it is understood that the embodiments of the invention although different are not necessarily mutually exclusive. The following detailed description is therefore, not to be taken in a limiting sense, and the scope of the present invention is defined by the appended claims, along with the full scope of equivalents to which said claims are entitled.

This design contains specific elements that are currently available, but it does not limit future technology developments.

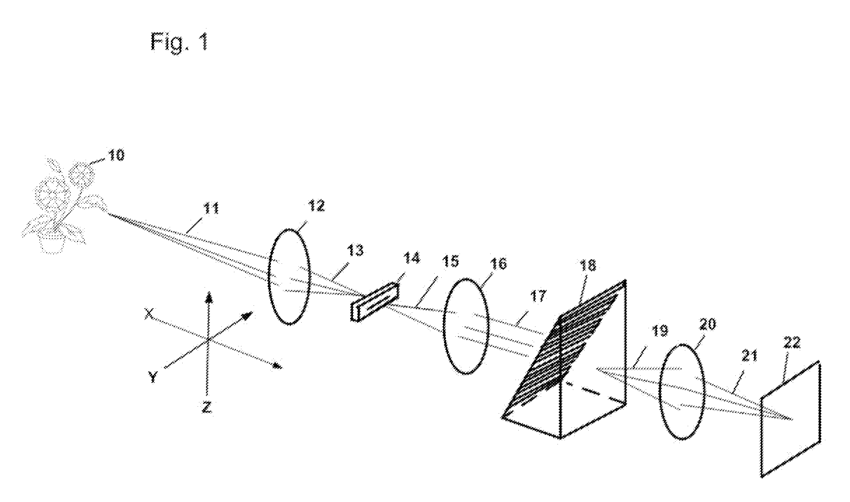

FIG. 1 sets forth a typical imaging device setup such as a hyperspectral camera, which operates in the manner set forth. The target, 10 which can be any number of objects, be it animate or imamate is scanned by the scanning assembly which takes in light 11 and follows through the path here set. The light passes through the initial lens, 12 and is spread, 13 and focused through a focal plane shutter, 14. The light exits the focal plane shutter 15 and is passed to the fore lens, 16. The light then exits the lens and is spread according to the manufacture of the lens 17, and falls on the spectrograph 18, here noted as a prism. It could be a prism-grating-prism or other spectrograph configuration. Exiting the prism, the light is spread 19 and then falls on the final lens, 20 which again focuses the beam of light 21 and passes it on to the sensor array 22. The sensor array can be composed of any number of substances, including a CCD, CMOS, sCMOS, carbon nanotube and future iterations.

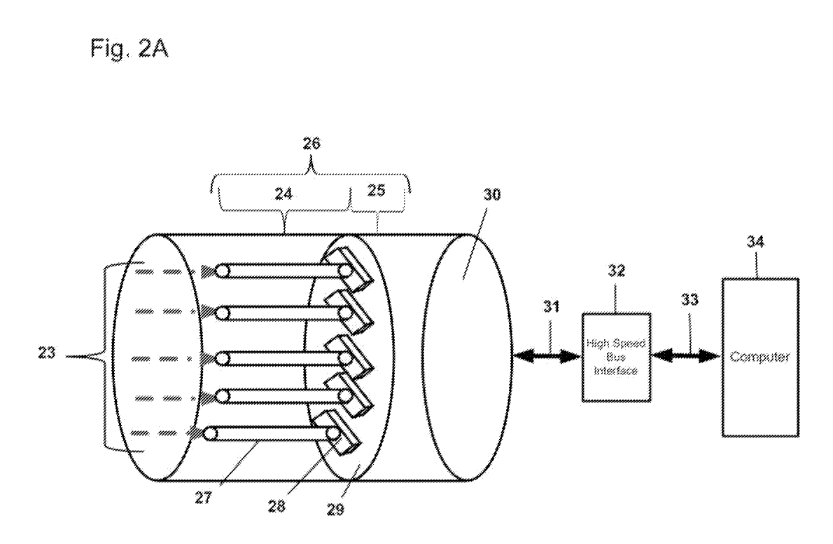

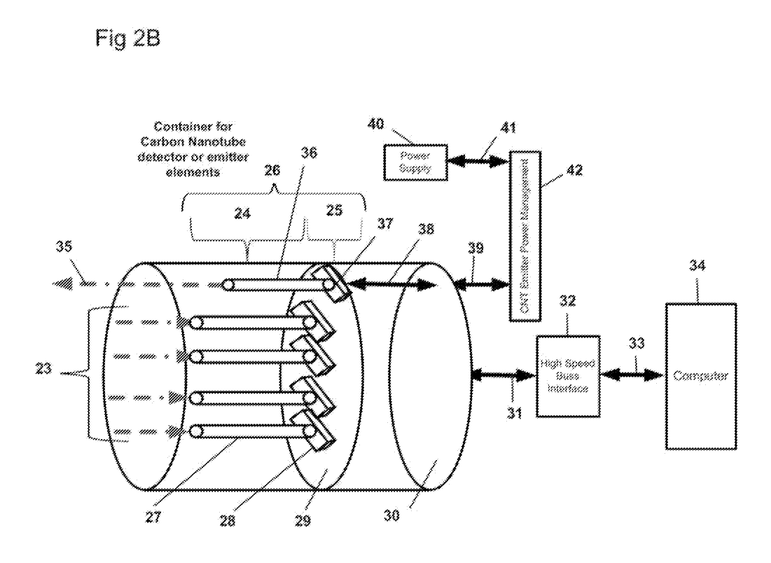

FIG. 2A illustrates the first embodiment of the invention and the components and processes that are necessary for its operation. The structure is a sensor array that can have one or many pixels arranged in rows and columns. The pixel container (pixelwell) represents each pixel. There may be one or many different CNT sensor elements in each pixel container. These are grouped together so that when the data scan occurs it is sequential. It may also be possible to BIN groups of pixels together in an ordered way. The pixel container well structure is composed of two parts: the imaging carbon nanotube forward containment assembly 24 and 25 which is the imaging carbon nanotube back assembly with interface circuitry to form the sensor well 26 which is the carbon nanotube containment assembly comprised of carbon nanotubes, assembly and support area for interface electronics. This structure takes in light which is optical radiation entering imaging carbon nanotube containment assembly, 23 and the carbon nanotube sensor elements in the pixel well structure 27 are anchored to the base of the containment assembly 29 either horizontally or vertically by anchors 28 to the containment assembly. These sensor elements are carbon nanotubes and are attached to the bottom of the containment assembly 30 by electronics and other interfaces 31 which is the connection between the nano-circuitry and the high speed BUS interface going to the CPU and GPGPU, 32 which is the high speed BUS interface that translates the information from nano-size to regular size and pass the data 33 which is the connection between the high speed bus interface to the computer bus attached to a computer with CPU and GPGPU components 34.

In reference to FIG. 2B a second embodiment, the setup is the same as FIG. 2A except emitter elements 36, are added and produce light which is optical radiation exiting from the emitter element 35. The emitters in each pixel container emit light like an LED. Each Pixel container could contain one or a plurality of these emitters. They may emit electromagnetic radiation in one or a plurality of frequencies. The individual emitters and the individual sensor elements could also be utilized together in calculating the distance from and object back to the imager system and the individual pixel container. It would then be possible to drive exacting distance and positional information similar to the separate operation of a positional system and a separate imaging system. This system could be utilized in ranging in remote sensing aerial systems or in microscope systems and providing exacting ranging and positional information in microscopy systems. In addition, the emitter elements have a different interface which is the attachment to the containment assembly 37 to the well bottom 29. In 38, the data is passed from the emitter element via 38 and 39 to the carbon nanotube emitter power management module 42. The data is then routed via 41 to a power supply 40. The duplicate numbers will not be included, for reference, refer to FIG. 2A for explanation.

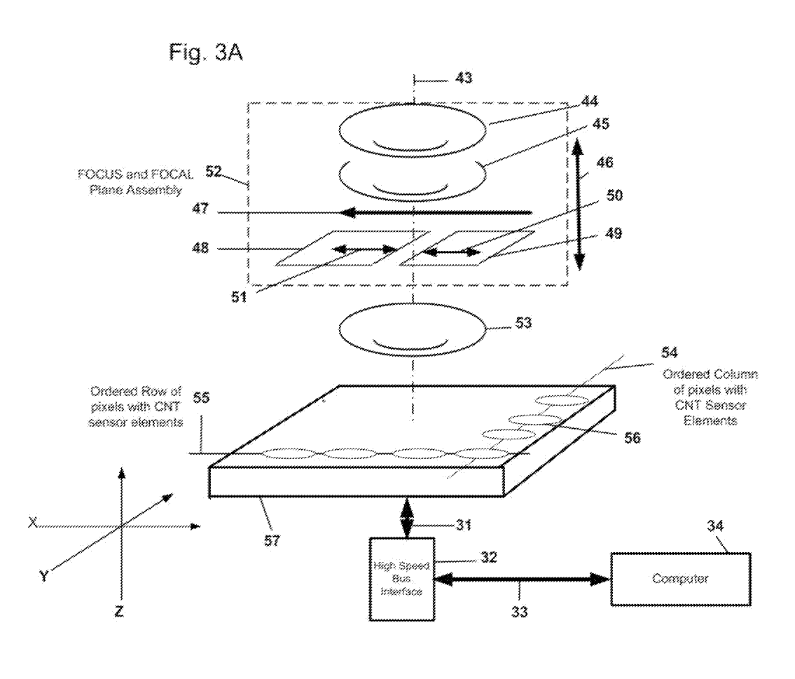

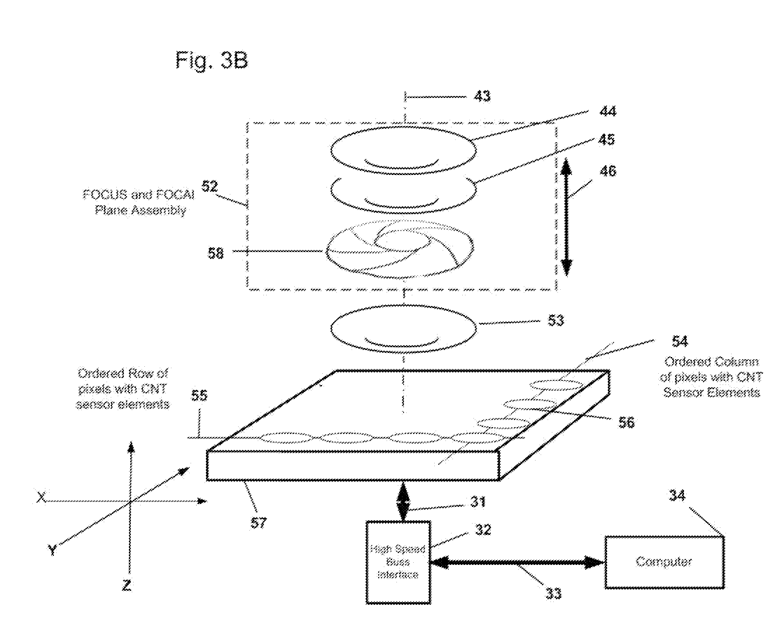

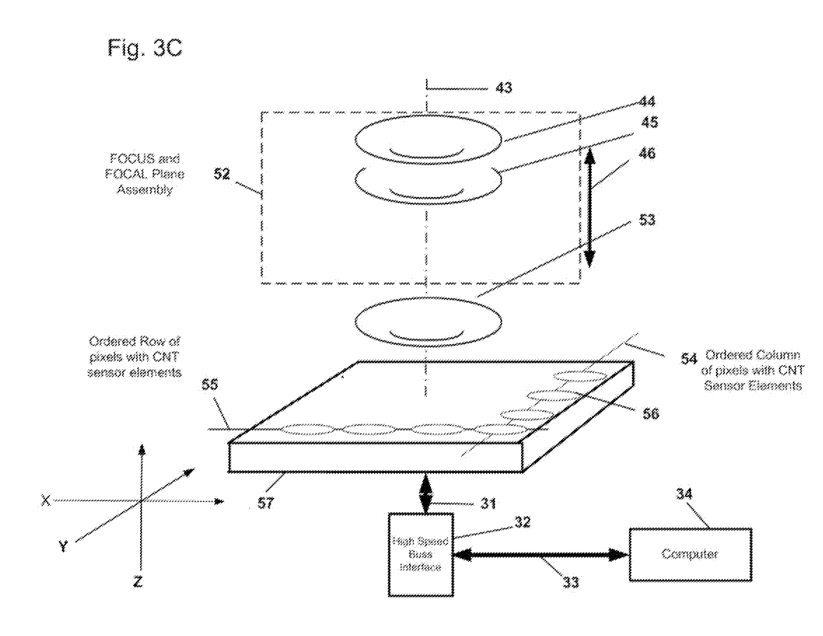

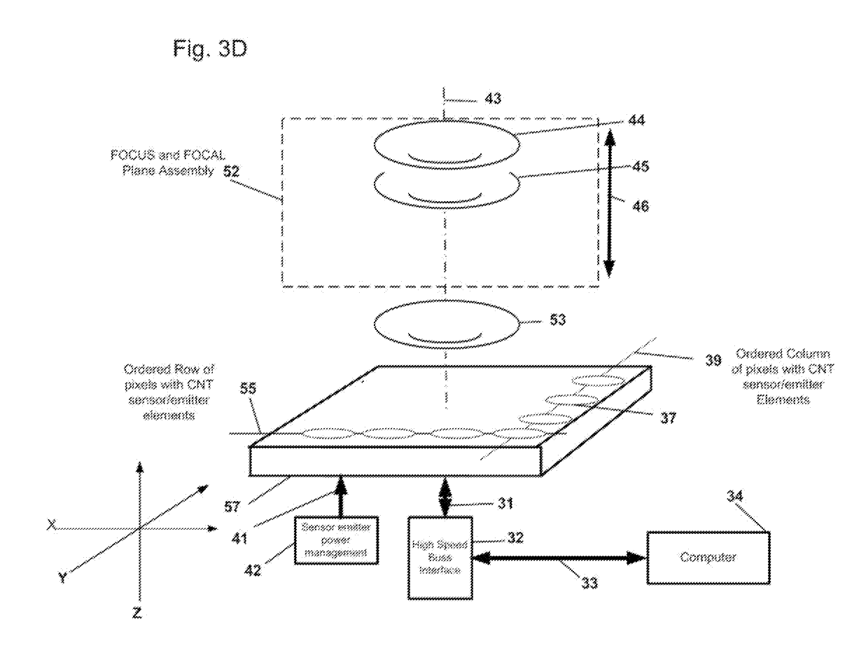

In FIG. 3A which is the third embodiment of the invention, the initial parts to the entire imaging system with a focal plane shutter 48, 49 setup are indicated; in one iteration, the light enters the assembly 43 and passes through the front lens 44 and on to the second lens 45. As the electromagnetic radiation leaves the second lens it enters the focal plane shutter 48, 49 which can move in the directions 46, 47, 50, 51, for size and direction adjustment, and movement of the focus plane. The electromagnetic radiation exits the focal plane assembly 52 and is passed to the rear lens 53 and onto the ordered column of carbon nanotube containment vessels also called CNT pixel elements in a column 54 and the row of same 55. The entire assembly of these sensor pixel elements is called an imaging sensor with carbon nanotube containment vessels that in turn contain 1-N carbon nanotube sensor elements 57. The electromagnetic radiation is then passed through the connection between the nano-interface circuitry, to a large scale high-speed bus interface going to the CPU and GPGPU. The path then goes to the high-speed bus interface which converts the signals from nano-scale to a larger scale. Refer to FIG. 2A for an explanation of 31, 32, 33, 34.

In FIG. 3B a fourth embodiment of the invention is illustrated, and the explanation is the same as FIG. 3A except for 58 where the standard focal plane assembly, 48, 49 is replaced with an iris shutter 58. The rest of the callouts are the same as FIG. 2A and are not repeated.

The diagram in FIG. 3C incorporates a fifth embodiment of the invention, where again, the assembly is identical, and the explanations can reference FIG. 2A, except the focal plane assembly has been removed altogether but the focus plane can be adjusted by moving the lens. The light simply passes from the second lens, 45 to the third lens 53. This setup is warranted in a variety of settings where a mechanical shutter is impractical.

The sixth embodiment of the invention is outlined in FIG. 3D; the identical callouts are in reference to 3A and 3C. The differences are that this diagram includes the emitter elements 36 and the connection to the emitter control and power 41 and the sensor power management 42.

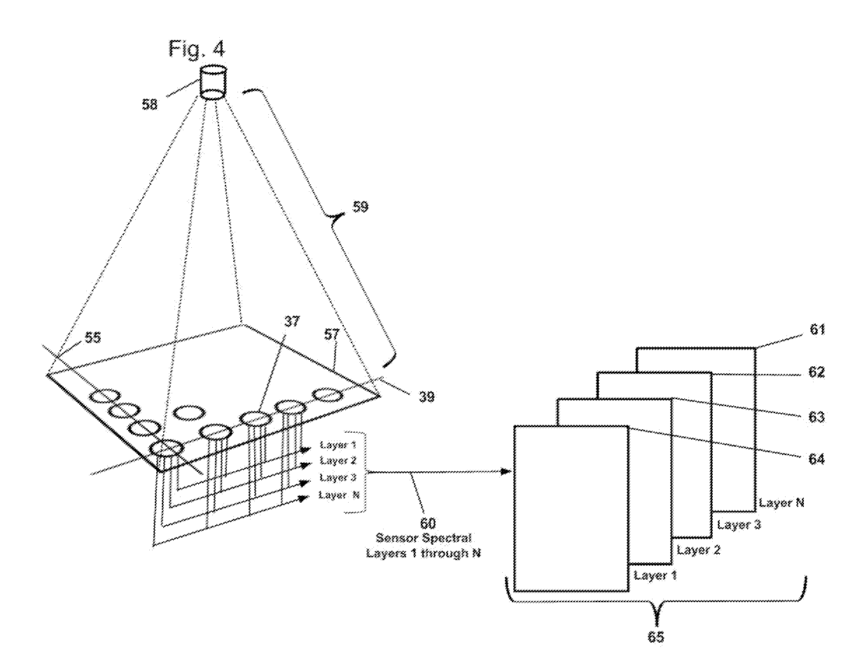

The diagram in FIG. 4 outlines the same basic design as FIG. 3A-3D except that the light source 58 is indicated as well as the path the electromagnetic radiation follows 59 to the row 55 and column 39 configurations of the pixel sensor elements 37 in their configuration 57. In addition, the circuitry attached to each pixel sensor elements composed of carbon nanotubes, 37 is noted 60 and demonstrated in a layered fashion for which the layout of the substrate is composed. In callouts 61-64 individual slices of the elements that make up a datacube, 65 are outlined. Each spectral frequency is collected from same onto one or many spectral sensor containers in the sensor. This collection is gathered and sent to the computer which assembles a spectral data cube containing one or many spectral slices ordered the same as the row and column ordering or where sensor containers (pixels) are binned together. Each spectral layer is a unique spectral frequency 61. N-number of spectral frequencies 62, 63, 64, represents one to a plurality of spectral frequencies that are represented on the representation 65. A data cube is a three (or higher) dimensional array of values collected individually from pixel containers and the individual sensor elements in each container. This is commonly used to describe a “timed series” of image data.

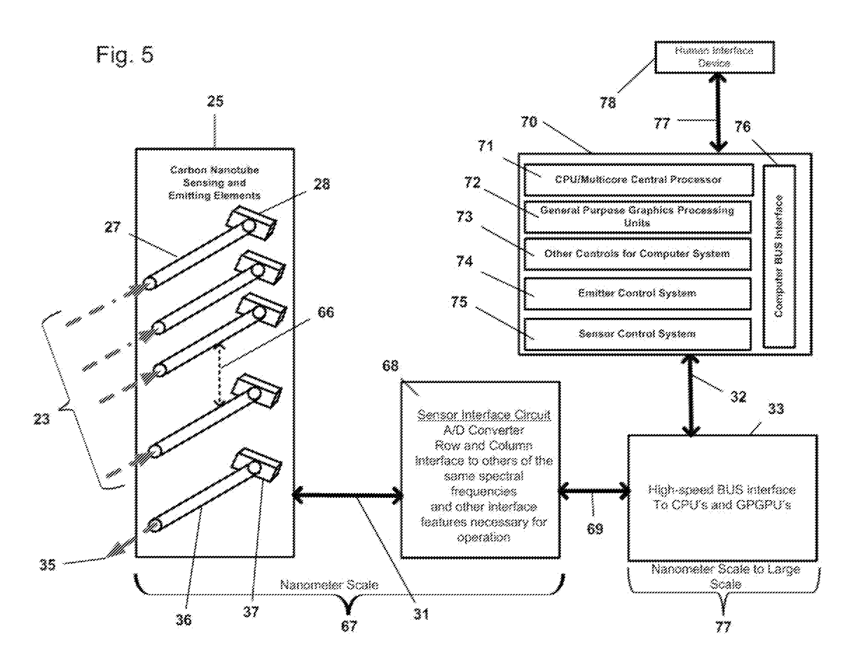

In FIG. 5 the elements in the containment vessel are identical to FIG. 2B. The carbon nanotube sensor elements are linked via 66 and are represented in the nanoscale 67 and attached via 31 to electronics, the carbon nanotube back assembly with circuitry, to the sensor interface circuit, 68. This circuit contains provisions for operations such as A/D conversion, Row and Column interface to containment vessels and their sensor elements, and other features necessary for the operation of the sensor. The circuit and the containment vessel together operate on a nano-scale as opposed to a larger scale commonly implemented. In 69, the sensor interface circuit is connected via 69 to the high-speed bus interface to the CPUs and GPGPUs 33. This interface converts the nano-scale information to information read by standard computer interfaces. The connection 32 to the computer 70 which contains many elements, such as a CPU/Multicore central processor 71, GPGPUs 72, other controls for the computer system 73, emitter control system 74, sensor control system 75 and the computer bus interface 76. Via 77 the processor system is connected to the human interface devices such as video, keyboard, mouse and other controls 78.

The various embodiments described above are provided by illustration only and should not be construed to limit the scope of the invention. In addition, for more information regarding carbon nanotubes, and implementations that may be used in connection with the present invention, reference may be made to the attached references which form a portion of the underlying patent document and are incorporated herein by reference.

### ADVANTAGES

From the above embodiments, it becomes evident that a number of advantages become evident.

a) Carbon nanotube technology is just starting to be utilized in the mainstream for displays, FET, ring oscillators, biological, mechanical, gaseous sensors, and a host of other applications.
b) Sensors have morphed from traditional CCD arrays, to CMOS, sCMOS and ultimately carbon nanotubes. By using these sub-micron units; that are virtually stronger than steel, impervious to EMT pulses, and have shown the capability to both absorb light and produce a voltage as well as receive a voltage and fluoresce, sensors have evolved by leaps and bounds.
c) It has been shown using spectroscopy and Raman, that nanotubes can absorb different wavelengths of light depending on the diameter and chirality of the nanotube. This factor in particular makes them a perfect candidate for an optical sensor. A sensor that is combined with an imaging system; takes in light in a wide range of frequencies and converts the signals and output into a 2D or 3D datacube.
d) By using carbon nanotubes, not only is the sensor very small, but it takes the place of the point that slows the system down, the scanning operation and the spectrograph. By replacing these elements in a system, the light impinges, through a series of lenses, directly with the sensor.
e) The sensor is contained of pixel containers, each which has 1-N number of sensor elements, which are carbon nanotubes. These nanotubes produce a voltage that is then manipulated by the sensor electronics and fed into a CPU/GPGPU.
f) By using this sensor system, the slow aspects of imaging that sometimes plagues traditional imaging devices, is eliminated, and is replaced by a fast row and column imaging scheme.
g) By using emitters in the system, carbon nanotubes, that with an applied voltage fluoresce, the entire device can receive light, analyze it and collect the data from the emitters enabling lighting and absorption from the same sensor.

### Conclusions, Ramifications, Scope

Accordingly, the reader will see that the complete system introduces new technology on a macro and micro-scale.

The units are flexible—they are chosen based on the application at hand. They can be used with existing and future technology. They are manufactured with state-of-the are sensors, including sCMOS and in the future carbon nanotubes. The movement of the focal plane and sensor assembly is under patent consideration.

The entire system is enclosed in a compact footprint, under 3 pounds or less. By integrating all of these functions, the system is able to remove the data burden and move it from the external device to the sensor via high-speed bus.

Although the description above contains much specificity, these should not be construed as limiting the scope of the embodiments but as merely providing illustrations of some of the presently preferred embodiments. For example, as technology progresses the system make up, shape, size and other parameters could change. In addition, as illustrated in figures (FIG. 3A, 3B, 3C, 3D) the complete system remains static in some senses, but incorporates different types of pixel arrays. Also the system is boosted by one or a multitude of attached GPUs to further speed up the process. The processing unit provides a multitude of functionality within the system (FIG. 5).

### OTHER PUBLICATIONS

1. Phaedon Avouris and Joerg Appenzeller, “Electronics and Optoelectronics with Carbon Nanotubes”, The Industrial Physicist, 21.

2. Carbon Nanotube Optics and Optoelectronics, S.Heinze et al., Institute of Applied Physics, University of Hamburg, Jungiusstrasse 11, 20355, Hamburg Germany.

3. Achim Hartschum “Simultaneous Fluorescence and Raman Scattering from Single Carbon Nanotubes,” Science, 2003, 301, 1354.

4. A. Mohite, S. Chakraborty, P. Gopinath et al, “Displacement current detection of photoconduction in carbon nanotubes,” Applied Physics Letters, 2005, 86, 061114.

5. The Science and Technology of Carbon Nanotubes, K. Tanaka, T. Yamabe, K. Fukui (Eds.) Elsevier, 1999.

6. R. Martel et al. “Single- and multi-wall carbon nanotube field-effect transistors,” Physics Letters, Vol. 73, No. 17, 26 Oct. 1998.

7. Vasili Perebeinos, J. Tersoff and Phaedon Avouris “Electron-Photon Interaction and Transport in Semiconducting Carbon Nanotubes,” Physical Review Letters, PRL 94, 4 Mar. 2005.

8. Jia. Chen, et al. “Bright Infrared Emission from Electrically Induced Excitons in Carbon Nanotubes,” Science, 310, 1171 2005.

9. Applied Physics of Carbon Nanotubes, Fundamentals of Theory, Optics and Transport Devices. S. V. Rotkin, S. Subramoney (Eds.) Springer-Verlag Berlin Heidelberg, 2005.

10. J. A. Misewich, et al. “Electrically Induced Optical Emission from a Carbon Nanotube FET,” Science 300, 783 2003

What is claimed is:

1. A complete carbon nanotube sensing element container and imaging array system for both receiving and emitting electromagnetic radiation of a wide variety of frequencies comprising:
a. a pixel container with 1-N number of sensing and emitting elements that are changed based on the change in light wavelength and subsequent optical absorption or emission based on the physical qualities of the carbon nanotubes;
b. applying light to the nanotubes;
c. receiving light which is absorbed by the carbon nanotubes;
d. emitting light triggered by voltage applied to the carbon nanotubes;
e. determining the change in optical absorption triggered by the light received in step (b);
f. incorporating supporting electronics into the sensor elements;
g. employing multiple iterations of an internal sensing system;
h. gathering electronic signals;
i. interpreting these signals;
j. providing the means to gather the signals and pass them on to a processing device;
k. using an integrated imaging system
l. producing a 2D or 3D datacube

2. According to claim 1, wherein the pixel container is a container for a number of sensing elements.

3. According to claim 1, wherein the light source is external to the system and can be composed of a wide range of elements.

4. According to claim 1, the voltage created is a result of light impinging on one or a plurality of nanotubes in the container.

5. According to claim 1 wherein, the processing device can be a computer with a CPU and GPGPU.

6. According to claim 1, wherein the multiple iterations of the internal sensing system include:
a. an initial lens
b. a second lens
c. a focal plane
d. a third lens
e. the carbon nanotube sensor array

7. According to claim 2 wherein the pixel container can contain carbon nanotube emitting elements.

8. According to claim 2, wherein the sensing elements are carbon nanotubes.

9. According to claim 2, the change in the diameter and chirality determines the specific wavelength of light that is absorbed or emitted.

10. According to claim 2, wherein the pixel container is composed of
a. the imaging carbon nanotube forward containment assembly and
b. the imaging carbon nanotube back assembly
c. carbon nanotube sensing elements
d. carbon nanotube emitting elements
e. interface circuitry to and from the sensor well
f. a carbon nanotube containment assembly comprised of carbon nanotubes
g. interface from the nanotube sensor and emitter elements to the containment assembly floor
h. support area for interface electronics

11. According to claim 4, the voltage created by the light/nanotube interaction is fed to integrated electronics.

12. According to claim 5, wherein the computing device with CPU and GPGPUs can have multiple cores.

13. According to claim 5 wherein, the CPU has many functions including:
a. emitter control system
b. sensor control system
c. computer bus interface
d. connection to the human interface and the high speed interface to the GPGPUs

14. According to claim 6, wherein the sensing system can contain a traditional focal plane shutter.

15. According to claim 6, wherein the sensing system can have an iris focal plane shutter.

16. According to claim 6, wherein the sensing system can be void of a focal plane shutter.

17. According to claim 7, wherein the emitter elements can be placed on the exterior of the sensing array.

18. According to claim 8, wherein the sensing and emitting elements are arranged in a row and column configuration.

19. According to claim 9, the specific wavelength sensed by the sensing elements can span the electromagnetic spectrum.

20. According to claim 10, wherein the pixel container is the element that holds 1-N carbon nanotube sensors and emitters.

21. According to claim 11, wherein the support electronics provide basic functionality such as AID conversion, row and column interface and other needed calculations.

22. According to claim 12, wherein the processing device performs calculations and algorithms necessary to manipulate and process the data.

23. According to claim 12, the computer is attached to the sensor system via a high speed bus.

24. According to claim 13, wherein the CPU can have multiple cores.

25. According to claim 13, wherein the sensor control system is responsible for managing the output from the carbon nanotube sensor array and routing it to further processing units such as the GPGPUs.

26. According to claim 13, wherein the output from the emitter array is routed to the appropriate processing portion as the sensor array output system.

27. According to claim 17 wherein, the emitter elements receive voltage and output a range of light based on their physical configuration

28. According to claim 18 wherein, the imaging device scans the sensor array in a line or snapshot configuration in a row and column manner.

29. According to claim 19 wherein, the electromagnetic spectrum range could be from UV to SWIR.

30. According to claim 20 wherein, the sensors and emitters are annealed to a substrate.

31. According to claim 22 wherein, the data to be processed is gleaned from the scan by an imaging system.

32. According to claim 23, the computer is connected to the sensor array externally via a high speed cable, be it current or future technology.

33. According to claim 27 wherein the physical configuration of the emitter carbon nanotube is determined by the steps taken to manufacture and sort the tubes according to their diameter, chirality and other charistics necessary to ultimately select 1 to N nanotubes that emit a particular frequency of light.

34. According to claim 29 wherein, the carbon nanotube sensor elements are selected in a similar manner except that they are chosen based on the wavelengths of light they absorb.

35. According to claim 30 wherein, this substrate can be in any number of configurations, such as in layers.

36. According to claim 30 wherein, the substrate can have:
a. a conductive layer
b. a non-conductive layer
c. sensing
d. blocking
e. electric
f. di-electric
g. carrier
h. other needed substrates

37. According to claim 31 wherein, the imaging system can be a hyperspectral or other system.
